(19) United States
(12) Patent Application Publication
(10) Pub. No.: US 2025/0091473 A1
(43) Pub. Date: Mar. 20, 2025

(54) POWER SOURCES OF LOAD HANDLING DEVICES OPERATIVE ON A GRID FRAMEWORK STRUCTURE

(71) Applicant: OCADO INNOVATION LIMITED, Hatfield, Hertfordshire (GB)

(72) Inventors: Philip CORSER, Hatfield, Hertfordshire (GB); Yashlin NADESAN, Hatfield, Hertfordshire (GB); Irfan RIZVI, Hatfield, Hertfordshire (GB); Nathan COUNSELL, Hatfield, Hertfordshire (GB)

(73) Assignee: OCADO INNOVATION LIMITED, Hatfield, Hertfordshire (GB)

(21) Appl. No.: 18/832,423

(22) PCT Filed: Jan. 25, 2023
(86) PCT No.: PCT/EP2023/051832

§ 371 Date: Jul. 23, 2024

(30) Foreign Application Priority Data
Jan. 25, 2022 (GB) 2200956.7

(51) Int. Cl. B60L 53/80; B60L 50/40; B60L 50/50

(52) U.S. Cl. CPC B60L 53/80; B60L 50/40; B60L 50/50; B60L 2200/40; B60L 2260/32

(57) ABSTRACT

A method for exchanging a power source in a load handling device operative on a grid framework structure, the grid framework structure including a track system extending in a substantially horizontal plane and forming a grid pattern containing a plurality of grid cells; a plurality of upright columns supporting the track system; and a plurality of stacks of storage containers arranged in a plurality of storage columns located below the track system. The method includes removing a first power source from the load handling device; inserting the first power source into a first storage container in a first grid cell; removing a second power source from a second storage container in a second grid cell; and inserting the second power source into the load handling device.

### FIELD OF INVENTION

The present invention relates to the field of exchanging power sources of load handling devices operative on a track system of a grid framework structure. The grid framework structure supports remotely operated load handling devices on tracks located on a grid framework structure for handling storage containers stacked in the grid framework structure.

### BACKGROUND

The claimed invention is intended to provide improvements relating to energy storage systems for load handling devices operating in automated storage and retrieval systems.

Load handling devices are typically powered by rechargeable power sources. The rechargeable power sources, once depleted, need to be recharged in order to permit the load handling device to continue operating. Charging can take a significant amount of time, and reduce the useful operational time of the load handling devices.

When the rechargeable power source is a battery, the relatively long charging time of the battery can be as long as a couple of hours, which represents a significant downtime during which a load handling device remains inactive or inoperative. Where a number of load handling devices are operative in automated storage and retrieval system to fulfil customer orders within a given time slot, having one or more load handling devices remain idle for a significant amount of time has a detrimental impact on the ability of a fulfilment centre or distribution warehouse to fulfil orders in a timely manner. This is particularly the case where the load handling device contributes to a logistical system that provides home delivery of goods to a customer's premises upon receipt of an order of goods. Here, delivery information containing delivery addresses is used by online retailers such as Amazon and UK's Ocado to deliver goods to the customer's delivery address. To mitigate such a problem, online retailers such as UK's Ocado provide a buffer of load handling devices operative on the track system of the grid framework structure to cater for load handling devices that remain idle for charging. In an extreme case, time slots for the delivery of orders are extended to cater for this downtime.

Typically, load handling devices powered by lithium-ion batteries require a charge of 15 minutes for every 4 hours of discharge.

An alternative to charging the rechargeable power source at a charge station is for the rechargeable power source to be exchangeable, so that a depleted rechargeable power source in a load handling device can be exchanged for a fully charged rechargeable power source. Exchanging the rechargeable power source is much faster than charging a rechargeable power source when the rechargeable power source is inside the load handling device, and therefore negates the disadvantages of slow battery charging, reduces downtime, and contributes to the efficient fulfilment of customer orders.

Typically, a load handling device with a depleted rechargeable power source travels to an exchange station, where the depleted rechargeable power source is removed. The load handling device must then travel to a second exchange station in order to be fitted with a fully charged rechargeable power source.

However, when the rechargeable power source is removed from a load handling device, the load handling device temporarily loses its power supply. This poses two problems: power is needed to enable the load handling device to travel to another exchange station in order to receive a new rechargeable power source, and losing power means that the load handling device loses communication with the control system.

To solve these issues, the load handling device can be supplied with an auxiliary power source, both to enable the load handling device to travel to another exchange station and to maintain connection to control system.

In some examples, the rechargeable power source may be removed and a new one fitted at the same exchange station. While this is more efficient than requiring the load handling device to visit two different exchange stations, the exchange still requires several operations (removing the depleted rechargeable power source from the load handling device, moving the depleted rechargeable power source out of the way, installing a new rechargeable power source). An auxiliary power source is still required to keep the load handling device supplied with power during the exchange operation.

WO2018210923 (AutoStore) discloses a load handling device with a protruding section that protrudes into a neighbouring grid space, where the protruding section comprises a replaceable battery and battery compartment. In one embodiment, the load handling device interfaces with a first charging station to remove a depleted battery and moves under an auxiliary power source to a second charging station to collect a charged battery.

WO2019206440A1 (AutoStore) also discloses a capacitor power supply as an auxiliary power source for backup or to power the load handling device when moving between exchange stations during battery exchange operations.

The use of an auxiliary power source, though solving the problem of how to maintain power to the load handling device and how to provide sufficient power to move the load handling device to a second station where a new power source can be supplied, has the disadvantage that the auxiliary power source is an additional component with concomitant costs and maintenance requirements. The requirement for the load handling device to travel to a second station means that an additional move is needed, which further reduces the time for which the load handling device is not fulfilling customer orders, as well as requiring additional power. Also the control system is more complex, with the need for an algorithm to determine the location of a suitable station at which the load handling device can be fitted with a replacement power source.

A method is therefore needed of quickly and easily exchanging the power source of the load handling device.

### SUMMARY OF INVENTION

In one aspect, the invention provides a method for exchanging a power source in a load handling device operative on a grid framework structure, the grid framework structure comprising:
i) a track system comprising a first set of tracks extending in a first direction and a second set of tracks extending in a second direction, the second direction being substantially perpendicular to the first direction, the track system extending in a substantially horizontal plane and forming a grid pattern comprising a plurality of grid cells,
ii) a plurality of upright columns supporting the track system; and
iii) a plurality of stacks of storage containers arranged in a plurality of storage columns located below the track system,
   the method comprising the steps of:
a) removing a first power source from the load handling device;
b) inserting the first power source into a first storage container in a first grid cell;
c) removing a second power source from a second storage container in a second grid cell;
d) inserting the second power source into the load handling device.

This method advantageously provides a faster way of exchanging the power source. Since the exchange of the power source takes place actually on the grid framework structure, there is no requirement for the load handling device to travel to a different location in order to be provided with a charged power source. This saves time and energy, which in turn improves the operational efficiency of the load handling device.

The first and second storage container can be configured to contain one power source, or a plurality of power sources.

The method may further comprise the step of instructing a second load handling device to remove the first storage container containing the first power source from the first grid cell. The first power source may be a depleted power source that has run out of charge, and the second power source may be a fully-charged power source. The first storage container may be removed from the first grid cell when it contains at least one power source (i.e. the first power source), or alternatively the first storage container may be removed when it is full, i.e. when it contains as many power sources as it is configured to contain. The second load handling device may be the load handling device, i.e. the same load handling device that is undergoing the power source exchange, or a different load handling device.

The method may further comprise the step of instructing a third load handling device to deposit an empty storage container into the first grid cell. This is effectively replacing the first storage container, which has just been removed from the first grid cell, with an empty storage container. The empty storage container can then be used to contain further power sources removed from further load handling devices. The third load handling device may be the load handling device, i.e. the same load handling device that is undergoing the power source exchange, or a different load handling device. In addition the third load handling device may be the second load handling device, or a different load handling device.

The method may further comprise the step of charging the first power source after the first storage container has been removed from the first grid cell. In cases where the power source is rechargeable, after having been removed from the first grid cell in the grid framework structure the first storage container containing the first power source can be taken to a charging station, where the first power source can be recharged. In cases where the power source is not rechargeable, after having been removed from the grid framework structure the first storage container containing the first power source can be taken to a disposal area, where the first power source can be disposed of.

The advantage of charging the first power source after removing it from the grid framework structure is safety. Charging can be carried out in a separate area with appropriate fire protections and fire safety mechanisms, rather than in the grid framework structure.

The method may further comprise the step of instructing a fourth load handling device to remove the second storage container from the grid cell. The fourth load handling device may be the load handling device, i.e. the same load handling device that is undergoing the power source exchange, or a different load handling device. In addition the fourth load handling device may be the second and/or third load handling devices, or a different load handling device.

The method may further comprise the step of instructing a fifth load handling device to deposit a storage container containing one or more power sources in the second grid cell. The fifth load handling device may be the load handling device, i.e. the same load handling device that is undergoing the power source exchange, or a different load handling device. In addition the fourth load handling device may be the second and/or third and/or fourth load handling devices, or a different load handling device.

Removing the second storage container from the second grid cell and depositing a storage container containing one or more power sources effectively refreshes the supply of charged power sources available for exchanging. For example, when the second storage container is empty because all power sources it previously contained have been removed and inserted into load handling devices, a replacement container containing one or more fully charged power sources can be provided in order to ensure that fully charged power sources are available to be inserted into load handling devices.

In some examples, when the second storage container is empty, the storage container can be removed from the grid framework structure. In other examples, the empty second storage container can be used to replace the first storage container when the first storage container is removed from the grid framework structure.

When the second storage container is empty, it can be replaced by another storage container containing fully charged power sources. In some examples, a replacement storage container containing one or more fully-charged power sources can be brought into the grid framework structure by a load handling device raising the storage container up the port column, travelling on the track system, and placing the second storage container in the grid framework structure.

The load handling device may comprise a securing mechanism configured to releasably secure a power source within the load handling device. The securing mechanism may also provide the electrical coupling between the power source and the driving mechanism for driving the load handling device on the track system. This has the advantage of a simpler construction with fewer parts: instead of two separate systems for securing and for electrically coupling the power source, one system can perform both functions.

The load handling device may comprise an auxiliary power source. Advantageously, this allows the load handling device to maintain power to auxiliary systems (e.g. communication with a control system) while the power source is being exchanged.

The first and/or second storage container may comprise one or more compartments configured to contain a power source. In cases where the power source is a battery, for safety reasons it is important that the live terminals of power sources do not touch and cause a short circuit. This is true for both fully charged and depleted batteries. Having separate compartments in the first and/or second storage container helps to achieve this aim by keeping the power sources separate and ensuring that they are secured and cannot fall over or move around in the storage container. In some examples the compartments may be formed from insulated separators configured to keep the power sources upright.

Other fire safety measures may be applied to the storage container and/or the grid framework structure. For example, the material of the storage container may be fire-resistant, the storage container may release a fire suppressant to contain any fire, or the grid framework structure itself may be provided with sprinklers or other systems to contain and/or extinguish a fire.

The first storage container may comprise a fire suppression container comprising a fire suppressant material for safely containing an overheated power source. An overheated power source can be a power source that has exceeded a predetermined threshold temperature, for example a temperature at or slightly above the maximum operating temperature of the power source. For example, the fire suppressant material may be a granular material such as glass, perlite, or vermiculite. If the power source catches fire, the fire suppressant material melts and thus absorbs heat from the power source, thereby providing a cooling effect that helps to extinguish the fire. Also the melted fire suppressant material forms an impervious layer around the power source, thus preventing oxygen from the air from reaching the power source, which also helps to extinguish the fire. An advantage of using a granular material is that the material is densely packed, and has a large surface area, which enables the fire suppressant material to surround the overheating power source closely and to melt quickly, and the large surface area is effective for absorbing liquids.

In another aspect, the invention provides an apparatus for exchanging a power source in a load handling device on a track system of a grid framework structure,
the track system comprising a first set of tracks extending in a first direction and a second set of tracks extending in a second direction, the second direction being substantially perpendicular to the first direction,
the grid framework structure comprising the track system, a plurality of upright columns supporting the track system, and a plurality of stacks of storage containers arranged in storage columns located below the track system,
the apparatus comprising a robot base located on a grid cell and a robot arm coupled to the robot base,
   wherein the robot arm is configured to carry out the method described herein.

In another aspect, the invention provides a system for exchanging a power source in a load handling device on a grid framework structure, the system comprising:
i) a grid framework structure comprising a track system comprising a first set of tracks extending in a first direction and a second set of tracks extending in a second direction, the second direction being substantially perpendicular to the first direction, the track system extending in a substantially horizontal plane and forming a grid pattern comprising a plurality of grid cells;
ii) a plurality of upright columns supporting the track system;
iii) a plurality of stacks of storage containers arranged in a plurality of storage columns located below the track system;
iv) a load handling device comprising a first power source for supplying power to move the load handling device on the track system;
v) a first storage container in a first grid cell;
vi) a second storage container containing a second power source for the load handling device, the storage container arranged in a second grid cell; and
vii) picking means configured for removing/inserting a power source from/into the load handling device.

The power source is exchanged by a picking means configured for removing/inserting a power source from/into the load handling device. The picking means could be any means which is able to pick up and move a power source, for example a robot arm, a gripper, a crane, a magnet, a human worker, or a manual tool (e.g. a gripper or a pair of tongs) manipulated by a human worker.

The system may further comprise a control system configured to control the picking means to carry out the method as described herein.

The picking means may comprise a robot comprising a robot base and a robot arm coupled to the robot base, the robot base being located on a third grid cell of the track system.

The system may further comprise:
i) a robot comprising a robot base and a robot arm coupled to the robot base, the robot base being located on a third grid cell of the track system;
ii) a control system comprising a processor and a data storage means comprising computer executable instructions such that, when executed by the processor causes the robot to replace the first power source with the second power source in the load handling device.

Advantageously, the robot arm can reach into grid cells adjacent to the third grid cell on which the robot base is located. In some examples the robot arm can reach grid cells that are not adjacent to the third grid cell on which the robot base is located. Advantageously, this means that one robot arm can service a range of grid cells so the load handling device does not have to travel so far in order to exchange its power source. Also, one robot arm can exchange the power source of multiple load handling devices efficiently: if several load handling devices are forming a queue to be serviced by the same robot arm, there is no need for the next load handling device in the queue to wait for the previous load handling device in the queue to move out of the way in order to approach the third grid cell, since there is enough space for several load handling devices around the third grid cell. Thus, fast and efficient exchange can be achieved.

In some examples, the robot arm may be capable of movement with six degrees of freedom, which advantageously provides flexibility of movement, so that the power source can easily be moved to the required position in the load handling device or in the storage container. In other examples, the robot arm may be mounted on a gantry crane.

The robot arm may be provided with an end effector, for example a clamping device or suction cup, to facilitate holding and lifting the power source.

The robot base may be mounted to the third grid cell. Advantageously, this provides stability to the robot base.

The robot base may comprise a wheel assembly and be configured to move on the track system of the grid framework structure. Advantageously, this permits the robot base to service a larger area of the track system. Also, this has the advantage that if a load handling device becomes fully discharged such that it does not have sufficient power to move on the track system, the robot base can approach the load handling device and exchange its power source. Otherwise, the load handling device would be stranded on the track system, and operation of the grid framework structure would need to be paused in order to retrieve the load handling device.

The control system may be further configured to instruct the robot to place the first power source in the first storage container in the first grid cell.

The control system may be further configured to instruct a second load handling device to remove the first storage container containing the first power source from the first grid cell. The second load handling device may be the load handling device.

The control system may be further configured to instruct a third load handling device to deposit an empty storage container into the first grid cell. The third load handling device may be the load handling device.

The control system may be further configured to instruct a fourth load handling device to remove the second storage container from the second grid cell. The fourth load handling device may be the load handling device.

The control system may be further configured to instruct a fifth load handling device to deposit a storage container containing one or more power sources in the second grid cell. The fifth load handling device may be the load handling device.

As described above, any or all of the second, third, fourth, and fifth load handling devices may be the load handling device, i.e. the same load handling device that is undergoing the power source exchange, or a different load handling device. In addition any of the second and/or third and/or fourth and/or fifth load handling devices may be the same load handling device, or a different load handling device.

The first container may be a fire suppression container comprising a fire suppressant material for safely containing an overheated power source.

Batteries which are largely based on lithium-Ion, nickel-cadmium, nickel-metal hydride, or lithium-ion polymer battery technologies rely on a chemical reaction to store electrical energy. For the purpose of the present invention, the term battery is construed to mean a battery pack consisting of one or more electrochemical cells with external connectors, i.e. positive and negative terminals. An optional external connector may be present on the battery for sending signals regarding the status of the battery. The individual electrochemical cells making up the battery can be connected in series and/or parallel. The effectiveness of these batteries diminishes after repeated charging due to the breakdown of the lithium ion cells, and therefore the ability of the battery to store charge for a prolonged period of time diminishes over time. Exchangeable rechargeable power sources have the advantage that removing the power source is a normal part of the operation of the load handling device rather than a separate maintenance operation, so when an aged battery is to be retired from use it can simply be withdrawn from circulation when removed from the load handling device at an exchange station, without the requirement for an additional maintenance operation.

### BRIEF DESCRIPTION OF THE DRAWINGS

Further features and aspects of the present invention will be apparent from the following detailed description of an illustrative embodiment made with reference to the drawings, in which:

FIG. 1 schematically illustrates a grid framework structure and storage containers;

FIG. 2 schematically illustrates track on top of the grid framework structure illustrated in FIG. 1;

FIG. 3 schematically illustrates load handling devices on top of the grid framework structure illustrated in FIG. 1;

FIG. 4 schematically illustrates a single load handling device with container-lifting means in a lowered configuration;

FIG. 5 schematically illustrates cutaway views of a single load handling device with container-lifting means in a raised and a lowered configuration;

FIG. 6 is a flowchart illustrating a method of exchanging a power source according to an aspect of the invention.

FIG. 7 is a schematic illustrating a method of exchanging a power source according to an aspect of the invention.

FIG. 8 is a perspective view of a robot arm according to an aspect of the invention.

FIG. 9 is a perspective view of a robot arm mounted to a grid cell of a grid framework structure.

FIG. 10 is a perspective view of a robot arm mounted to a grid cell of a grid framework structure.

FIG. 11 is a perspective view of a load handling device and a robot arm on a grid framework structure.

FIG. 12 is a perspective view of a load handling device and a robot arm mounted to a grid cell of a grid framework structure.

FIG. 13 is a perspective view showing a robot arm with an end effector comprising a clamping device.

FIG. 14 is a flowchart illustrating a method of exchanging a power source in a load handling device in the case where the power source is overheating.

FIG. 15 (a to c) schematically illustrates a fire suppression container partially filled with a granular fire suppressant material.

FIG. 16 (a to d) schematically illustrates a fire suppression container partially filled with a granular fire suppressant material contained in pouches.

FIG. 17 shows an example power source exchange station in the form of a robot located on a platform adjacent to the outer perimeter of a portion of the track system.

FIG. 18 shows an example power source exchange station with power source holders arranged in a horizontal plane within a storage structure.

### DETAILED DESCRIPTION

The following embodiments represent the applicant's preferred examples of how to implement a compliant track element, but they are not necessarily the only examples of how that could be achieved.

### Storage and Retrieval Systems

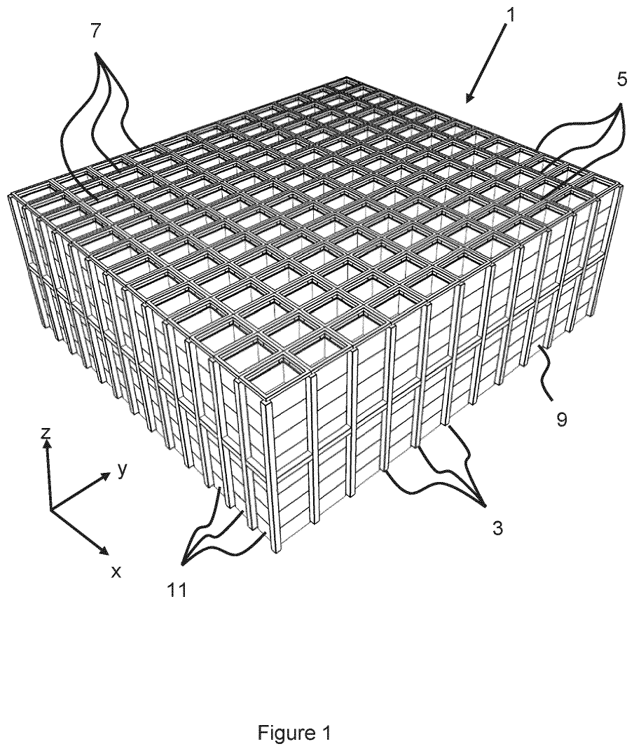

FIG. 1 illustrates a grid framework structure 1 comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, storage containers 9 are arranged in stacks 11 beneath the grid cells defined by the grid pattern, one stack 11 of storage containers 9 per grid cell.

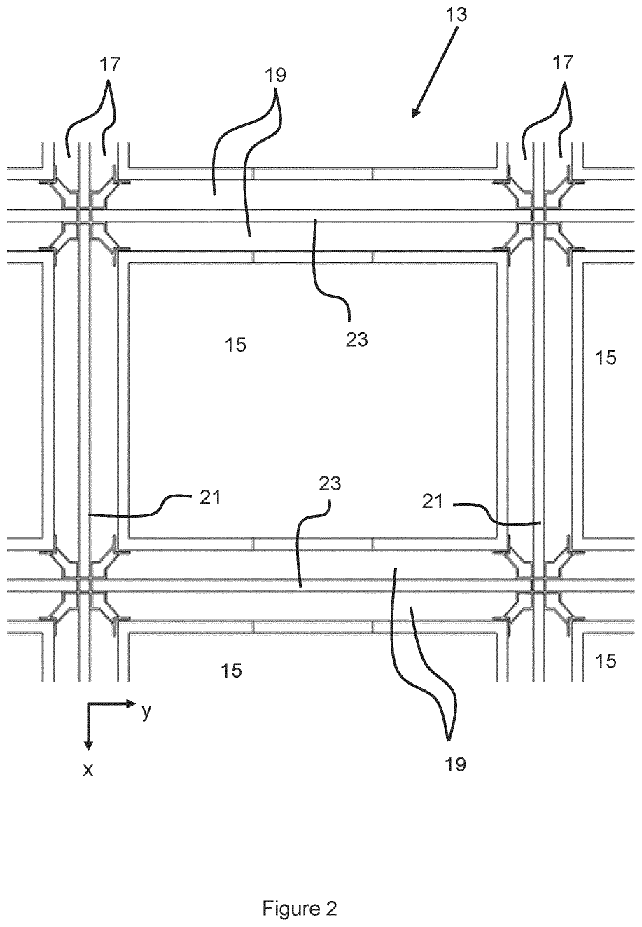

FIG. 2 shows a large-scale plan view of a section of track structure or track system 13 forming part of the grid framework structure 1 illustrated in FIG. 1 and located on top of the horizontal members 5, 7 of the grid framework structure 1 illustrated in FIG. 1. The track system 13 may be provided by the horizontal members 5, 7 themselves (e.g. formed in or on the surfaces of the horizontal members 5, 7) or by one or more additional components mounted on top of the horizontal members 5, 7. The illustrated track system 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow storage containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track system may also be possible.

As an alternative to the grid framework structure 1 supporting the two-dimensional track system 13 directly on the upright members 3 as illustrated in FIG. 1, in other examples the grid framework structure 1 supports the track system 13 on top of a plurality of prefabricated modular panels arranged in a grid pattern, the detail of which is described briefly below and fully in the PCT application, WO2022034195A1, in the name of Ocado Innovation Ltd, and incorporated herein by reference. This grid framework structure described in WO2022034195A1 addresses the problem of time and cost to assemble by supporting the 2D grid on a supporting framework structure comprising a plurality of prefabricated modular panels arranged in a three dimensional grid pattern to define a plurality of grid cells. Each of the grid cells of the supporting framework structure is sized to support two or more grid cells of the grid upon which the load handling devices operate. The grid framework structure is formed from fewer structural components yet still maintains the same structural integrity as the typical “stick-built” grid framework structure 1 described above where each node of the track system is supported by one upright member, and is much faster and cheaper to build.

The prefabricated modular panels of the grid framework structure 1 described above comprise upright members 3. For example, a sub-group of the upright members can be braced by one or more bracing members to form prefabricated panels or frames. For the purpose of the present invention, the upright members 3 can also include the upright members in the prefabricated panels. The grid framework structure 1 can comprise any appropriate supporting framework structure to support the grid, including upright members 3 directly supporting the grid, and/or prefabricated panels and/or frames incorporating upright members 3.

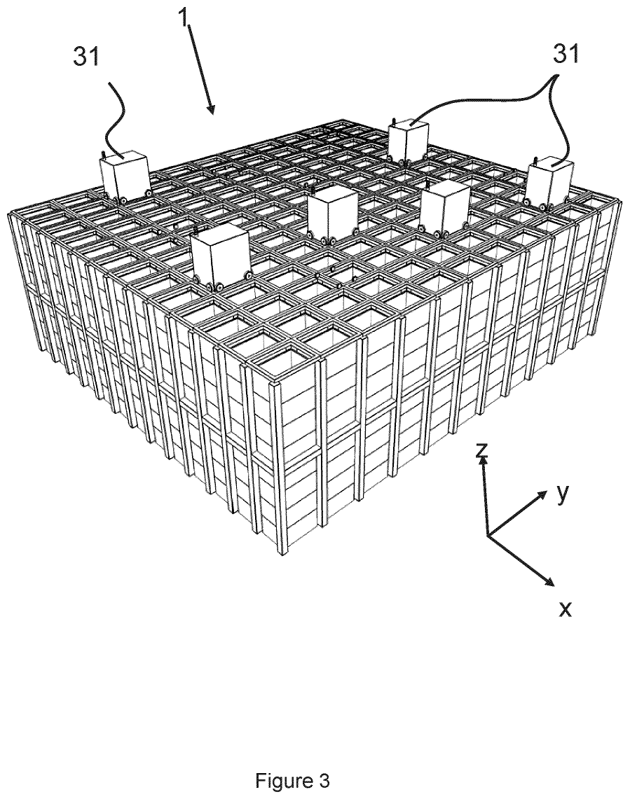

FIG. 3 shows a plurality of load handling devices 31 moving on top of the grid framework structure 1 illustrated in FIG. 1. The load handling devices 31, which may also be referred to as robots 31 or bots 31, are provided with sets of wheels to engage with corresponding x- or y-direction tracks 17, 19 to enable the load handling devices 31 to travel across the track system 13 and reach specific grid cells. The illustrated pairs of tracks 17, 19 separated by channels 21, 23 allow load handling devices 31 to occupy (or pass one another on) neighbouring grid cells without colliding with one another.

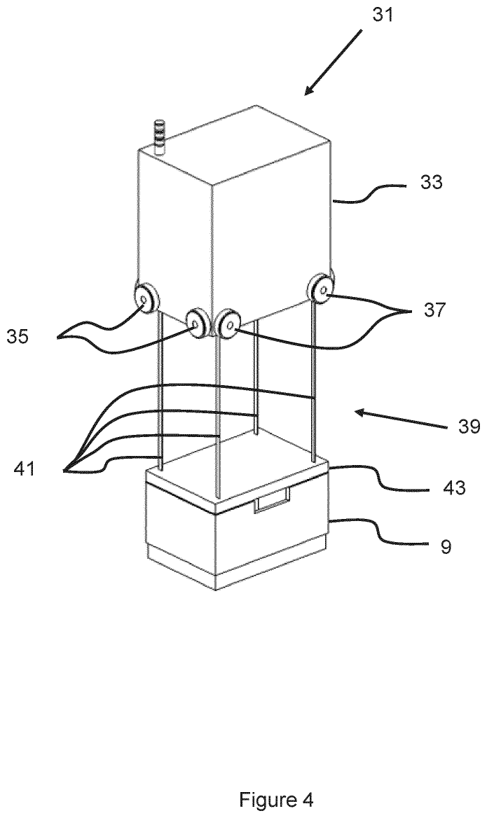

As illustrated in detail in FIG. 4, a load handling device 31 comprises a body 33 in or on which are mounted one or more components which enable the load handling device 31 to perform its intended functions. These functions may include moving across the grid framework structure 1 on the track system 13 and raising or lowering containers 9 (e.g. from or to stacks 11) so that the load handling device 31 can retrieve or deposit containers 9 in specific locations defined by the grid pattern.

The load handling device 31 comprises a wheel assembly 34. The embodiment of the load handling device 31 illustrated in FIG. 4 comprises first and second sets of wheels 35, 37 which are mounted on the body 33 of the load handling device 31 and enable the load handling device 31 to move in the x- and y-directions along the tracks 17 and 19, respectively. In particular, two wheels 35 are provided on the shorter side of the load handling device 31 visible in FIG. 4, and a further two wheels 35 are provided on the opposite shorter side of the load handling device 31 (side and further two wheels 35 not visible in FIG. 4). The wheels 35 engage with tracks 17 and are rotatably mounted on the body 33 of the load handling device 31 to allow the load handling device 31 to move along the tracks 17. Analogously, two wheels 37 are provided on the longer side of the bot 31 visible in FIG. 4, and a further two wheels 37 are provided on the opposite longer side of the load handling device 31 (side and further two wheels 37 not visible in FIG. 4). The wheels 37 engage with tracks 19 and are rotatably mounted on the body 33 of the load handling device 31 to allow the load handling device 31 to move along the tracks 19.

The wheel assembly 34 of the load handing device 31 may be driven by a driving mechanism 38. The driving mechanism 38 may comprise one or more motors.

The load handling device 31 also comprises container-lifting means 39 configured to raise and lower storage containers 9. The illustrated container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with features of the storage containers 9. For instance, the storage containers 9 may be provided with one or more apertures in their upper sides with which the engaging means can engage.

Alternatively or additionally, the engaging means may be configured to hook under the rims or lips of the storage containers 9, and/or to clamp or grasp the storage containers 9. The tapes 41 may be wound up or down to raise or lower the container-engaging assembly, as required. The container-lifting means 39 may be driven by a driving mechanism 38. The winding up or down of the tapes 41 of the container-lifting means 39 may be effected or controlled by the driving mechanism 38, which may comprise one or more motors or other means. The same driving mechanism 38 can be used to drive both the wheel assembly 34 and the container-lifting means 39, or separate driving mechanisms may be used.

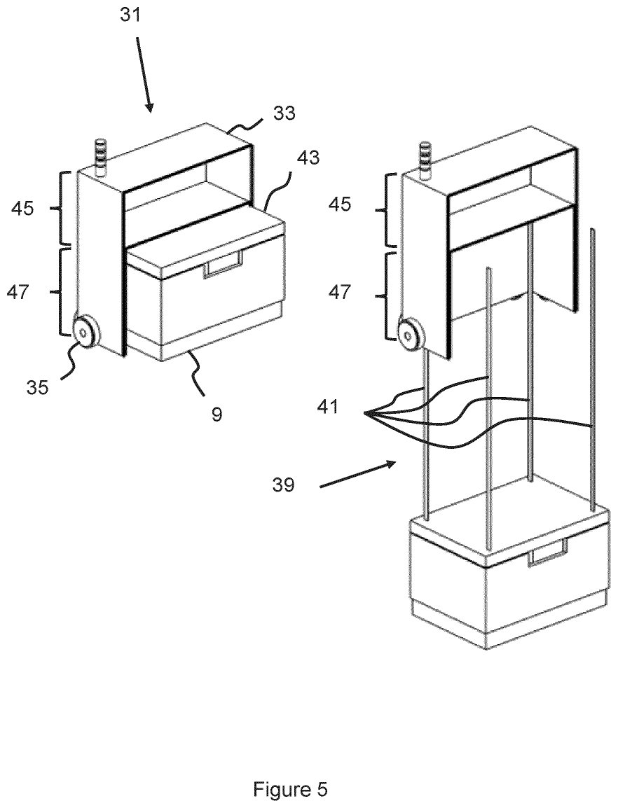

As can be seen in FIG. 5, the body 33 of the illustrated load handling device 31 has an upper portion 45 and a lower portion 47. The upper portion 45 is configured to house one or more operation components (not shown). The lower portion 47 is arranged beneath the upper portion 45. The lower portion 47 comprises a container-receiving space 49 or cavity for accommodating at least part of a storage container 9 that has been raised by the container-lifting means 39. The container-receiving space 49 is sized such that enough of a storage container 9 can fit inside the cavity to enable the load handling device 31 to move across the track system 13 on top of grid framework structure 1 without the underside of the storage container 9 catching on the track system 13 or another part of the grid framework structure 1. When the load handling device 31 has reached its intended destination, the container-lifting means 39 controls the tapes 41 to lower the container-engaging assembly 43 and the corresponding storage container 9 out of the container-receiving space 49 in the lower portion 47 and into the intended position. The intended position may be a stack 11 of storage containers 9 or an egress point of the grid framework structure 1 (or an ingress point of the grid framework structure 1 if the load handling device 31 has moved to collect a container 9 for grid framework in the grid framework structure 1). Although in the illustrated example the upper and lower portions 45, 47 are separated by a physical divider, in other embodiments, the upper and lower portions 45, 47 may not be physically divided by a specific component or part of the body 33 of the load handling device 31.

In some embodiments, the container-receiving space 49 of the load handling device 31 may not be within the body 33 of the bot 31. For example, in some embodiments, the container-receiving space 49 may be adjacent to the body 33 of the load handling device 31, e.g. in a cantilever arrangement with the weight of the body 33 of the load handling device 31 counterbalancing the weight of the container to be lifted. In such embodiments, a frame or arms of the container-lifting means 39 may protrude horizontally from the body 33 of the load handling device 31, and the tapes/reels 41 may be arranged at respective locations on the protruding frame/arms and configured to be raised and lowered from those locations to raise and lower a container into the container-receiving space 49 adjacent to the body 33. The height at which the frame/arms is/are mounted on and protrude(s) from the body 33 of the load handling device 31 may be chosen to provide a desired effect. For example, it may be preferable for the frame/arms to protrude at a high level on the body 33 of the load handling device 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track system 13) to keep the centre of mass of the load handling device 31 lower when the load handling device 31 is loaded with a container.

To enable the load handling device 31 to move on the different wheels 35, 37 in the first and second directions, the load handling device 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the grid framework structure 1.

The wheel-positioning mechanism may include one or more linear actuators, rotary components or other means for raising and lowering at least one set of wheels 35, 37 relative to the body 33 of the load handling device 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the load handling device 31 stays substantially at the same height and therefore the weight of the body 33 and the components mounted thereon does not need to be lifted and lowered by the wheel-positioning mechanism.

The driving mechanism(s) 38 used to drive the wheel assembly 34 and the container-lifting means 39 can be powered by a power source 50.

In some examples, the grid framework structure 1 may comprise one or more port columns or vertical chutes to facilitate the entry or removal of storage containers from the grid framework structure. A port column occupies one grid cell, bounded at the four corners by four of the vertical uprights of the grid framework structure. Vertical guides may be provided to guide the storage container in a vertical direction. To remove a storage container from the grid framework structure 1, a load handling device 31 carrying a storage container 9 in its container receiving space 49 travels to the grid cell at the top of the port column and lowers the storage container 9 down until the storage container 9 reaches the bottom of the port column. The container-engaging assembly 43 of the load handling device 31 then disengages from the storage container 9 and is lifted back into the body 33 of the load handling device. The storage container 9 at the bottom of the port column can then be removed, for example by a conveyor belt or vehicle or human operative.

To bring a storage container 9 into the grid framework structure 1, the same operation is used in reverse. The storage container 9 is brought to the bottom of a port column (for example, by a conveyor belt or vehicle or human operative). A load handling device 31 travels to the grid cell at the top of the port column and lowers its container-engaging assembly 43 down the port column. The container-engaging assembly engages with the storage container, and the container-lifting means 39 lifts the storage container 9 up through the port column and into the container receiving space 49 of the load handling device 31. The load handling device then travels on the track system to take the storage container to its destination location in the grid framework structure.

### Method of Exchanging a Power Source

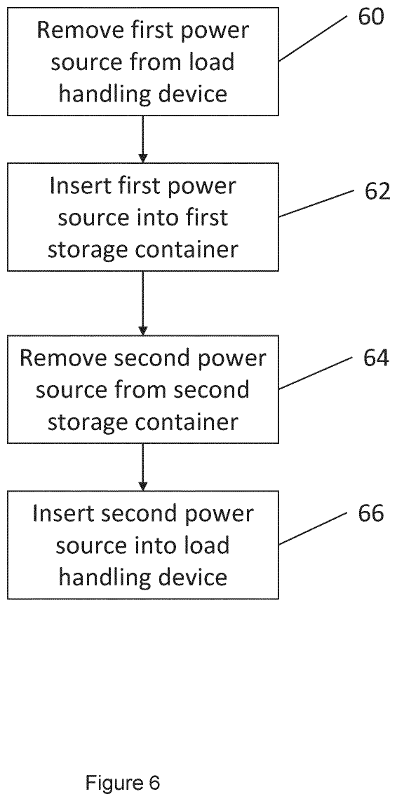

FIG. 6 is a flowchart illustrating a method of exchanging a power source 50 in a load handling device 31 according to an aspect of the invention. Exchanging the power source 50 may be required, for example, if the power source currently installed in a load handling device is depleted and no longer has enough charge to power the driving mechanism 38 of the load handling device. In other examples, the power source may be faulty or may be in need of maintenance. In the description that follows, the power source 50 to be removed from the load handling device 31 will be referred to as the first power source 50a, and the power source to be installed into the load handling device 31 to replace the first power source 50a will be referred to as the second power source 50b. The storage container 9 into which the first power source 50a will be placed will be referred to as a first storage container 9a, and the storage container 9 which contains the second power source 50b before the second power source 50b is installed in the load handling device 31 will be referred to as a second storage container 9b. The first storage container 9a is located in a first grid cell 14a of the grid framework structure and the second storage container 9b is located in a second grid cell 14b. In some examples the first power source 50a may be a partially or fully depleted power source, have a fault, or be in need of maintenance, and the second power source 50b may be a new or fully charged power source.

The power source is exchanged by a picking means configured for removing/inserting a power source from/into the load handling device. The picking means could be any means which is able to pick up and move a power source, for example a robot arm, a gripper, a crane, a magnet, a human worker, or a manual tool (e.g. a gripper or a pair of tongs) manipulated by a human worker.

As illustrated in the flowchart of FIG. 6, in a first step 60, the first power source 50a is removed from the load handling device 31. In a second step 62, the first power source 50a is placed or inserted into the first storage container 9a in the first grid cell 14a. In a third step 64, the second power source 50b is removed from the second storage container 9b in the second grid cell 14b. In a fourth step 66, the second power source 50b is inserted into the load handling device 31. The step of removing the first power source 50a from the load handling device and replacing it with a second power source 50b stored in the second grid cell 14b may be carried out by a robot mounted to the track system. Further detail of the robot is discussed below.

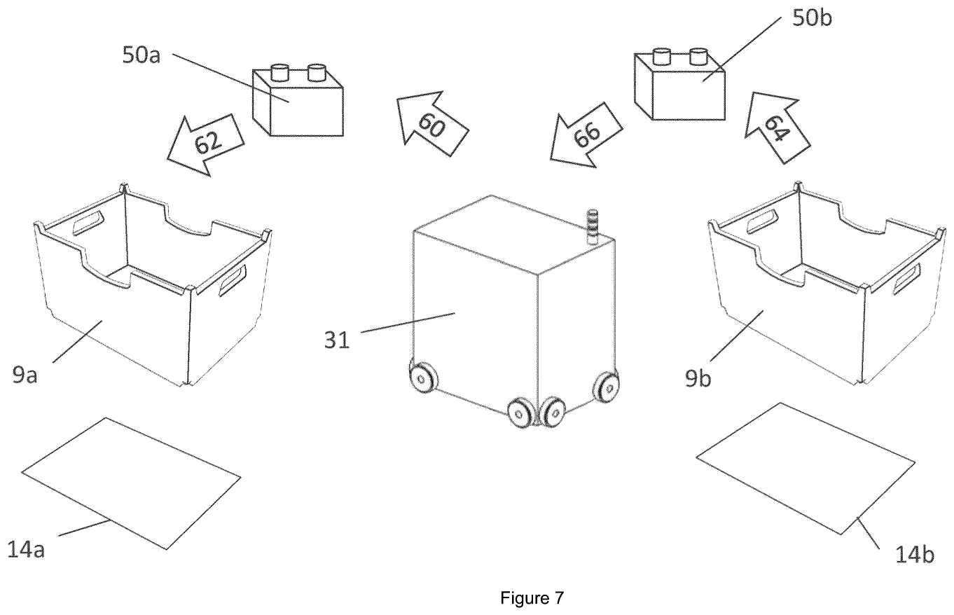

FIG. 7 illustrates the same method in a different representation. The load handling device 31, the first and second power sources 50a, 50b, the first and second storage containers 9a, 9b, and the first and second grid cells 14a, 14b are illustrated graphically. The arrows represent the method steps 60, 62, 64, 66 of the flowchart in FIG. 6, and indicate the transfer of the first and second power sources 50a, 50b out of and into the load handling device, and into and out of the respective first and second containers 9a, 9b in the respective first and second grid cells 14a, 14b. The first and second grid cells 14a, 14b are illustrated schematically for the purposes of illustration only, not to scale and not representing their actual or relative position.

After the first power source 50a has been removed from the load handling device 31 and placed in the first storage container 9a in the first grid cell 14a, the first storage container 9a containing the first power source 50a can be removed from the first grid cell 14a and from the grid framework structure 1. If the first storage container 50a is configured to hold more than one power source, advantageously the first storage container 50a may be removed when it is full, i.e. after several power source exchange operations have taken place for several load handling devices 31, and the first storage container 9a when it contains as many power sources 50 as it is configured to contain. This has the advantage that several depleted power sources can be removed from the grid framework structure in one operation.

The removal of the first storage container 9a form the first grid cell 14a of the grid framework structure can be carried out by a second load handling device 31. This could be the same load handling device that has had its power source exchanged, or a different load handling device. In order to remove the first storage container 9a from the first grid cell 14a of the grid framework structure 1, the second load handling device 31 can be instructed to travel on the track system 13 to the grid cell below which the first storage container 9a is located, i.e. the first grid cell 14a. The second load handling device 31 can then lower its container-engaging assembly 43, grip the first storage container 9a, and lift the first storage container 9a into the container receiving space 49 using the container lifting means.

The second load handling device 31 can then travel on the track system to a grid cell above a port column, lower the first storage container 9a down the port column, and disengage the container-engaging assembly from the first storage container 9a. Once at the bottom of the port column, the first storage container 9a can be carried away by a human operative, a conveyor belt, another vehicle, or any other suitable means.

A dedicated port column may be provided for storage containers containing power sources. To improve safety, the port column may be provided with fire-resistant walls, sprinkler systems, or any other suitable fire prevention means. This is particularly important in cases where the power source is a battery.

The method may further comprise the step of charging the first power source after the first storage container has been removed from the first grid cell of the grid framework structure. In cases where the power source is rechargeable, after having been removed from the grid framework structure the first storage container containing the first power source can be taken to a charging station, where the first power source can be recharged. In cases where the power source is not rechargeable, after having been removed from the grid framework structure the first storage container containing the first power source can be taken to a disposal area, where the first power source can be disposed of.

The advantage of charging the first power source 50a after removing it from the grid framework structure 1 is safety. Charging can be carried out in a separate area with appropriate fire protections and fire safety mechanisms, rather than in the grid framework structure 1.

Once the first storage container 9a has been removed from the first grid cell 14a of the grid framework structure 1, it can be replaced by an empty storage container 9 to contain further power sources 50 removed from further load handling devices 31. The empty storage container 9 can be brought to the first grid cell 14a by a third load handling device 31. The third load handling device 31 can be the same load handling device that has had its power source exchanged, and/or the second load handling device, or a different load handling device.

After the second power source 50a has been removed from the second storage container 9b in the second grid cell 14b and placed in the load handling device 31, the second storage container 9b which previously contained the second power source 50b can be removed from the second grid cell 14b of the grid framework structure 1. If the second storage container 50b is configured to hold more than one power source 50, advantageously the second storage container 50b may contain several power sources to allow several power source exchange operations to take place for several load handling devices 31. After all power sources 50 have been removed from the second storage container 9a, the second storage container 9b can be removed from the second grid cell 14b and from the grid framework structure. This can be carried out by a fourth load handling device 31 picking up the second storage container 9b, travelling on the track system 13 to a grid cell above a port column, and lowering the second storage container 9b down the port column. Alternatively, the empty second storage container 9b can be used to replace the first storage container 9a when the first storage container 9b is full. The fourth load handling device can be a separate load handling device to the load handing device which has just received the second power source from the second storage container, or the same load handling device receiving the second power source. The fourth load handling device can be the second and/or third load handling device, or a different load handling device.

Once the second storage container 9b is empty because all power sources 50 it previously contained have been removed and inserted into load handling devices 31, a replacement storage container 9 containing one or more fully charged power sources 50 can be provided in order to ensure that fully charged power sources 50 are available to be inserted into load handling devices 31. The replacement storage container containing one or more fully-charged power sources can be brought into the grid framework structure by a fifth load handling device raising the storage container up the port column, travelling on the track system, and placing the second storage container in the required location in the grid framework structure. The fifth load handling device 31 can be the same load handling device that has had its power source exchanged, and/or the second and/or third and/or fourth load handling device, or a different load handling device.

### Fire Suppression

Some power sources may carry a fire risk if subject to mechanical damage or high temperatures. For example, the power source 50 can be a lithium ion battery with a normal operating temperature of, for example, below 60° C. If the temperature exceeds the normal operating temperature, e.g. because of a short circuit, there is a risk that the battery will continue to increase in temperature, and if the temperature of the battery exceeds a thermal runaway threshold temperature (for example, 130° C.), the temperature may increase rapidly. Thermal runaway is a kind of uncontrolled positive feedback, and occurs in situations where an increase in temperature changes the conditions in a way that causes a further increase in temperature. In the case of lithium ion batteries, mechanical damage or a short circuit can lead to an uncontrollable exothermic reaction that emits large amounts of heat.

An initial increase in temperature can be caused by, for example, a short circuit, mechanical damage, a manufacturing defect, or heat from another source (e.g. charging, or other components in the load handling device). If the heat causes the separator between the cathode and anode to wear down or be damaged, a short circuit occurs, allowing large currents to flow directly between the anode and cathode, producing heat. At the onset of thermal runaway, the battery heats in seconds to very high temperatures, and the electrolyte breaks down and releases flammable and toxic gases. Mechanical damage can also result in the release of the electrolyte. The electrodes then begin to decompose via an exothermic chemical reaction, further accelerating the thermal runaway process. When the flammable electrolyte gases react with oxygen in the presence of heat, combustion occurs.

In a lithium-ion battery there can be several minutes between the initial increase of temperature, and thermal runaway. This time can be used to safely contain the battery and prevent a fire from spreading to other parts of the system.

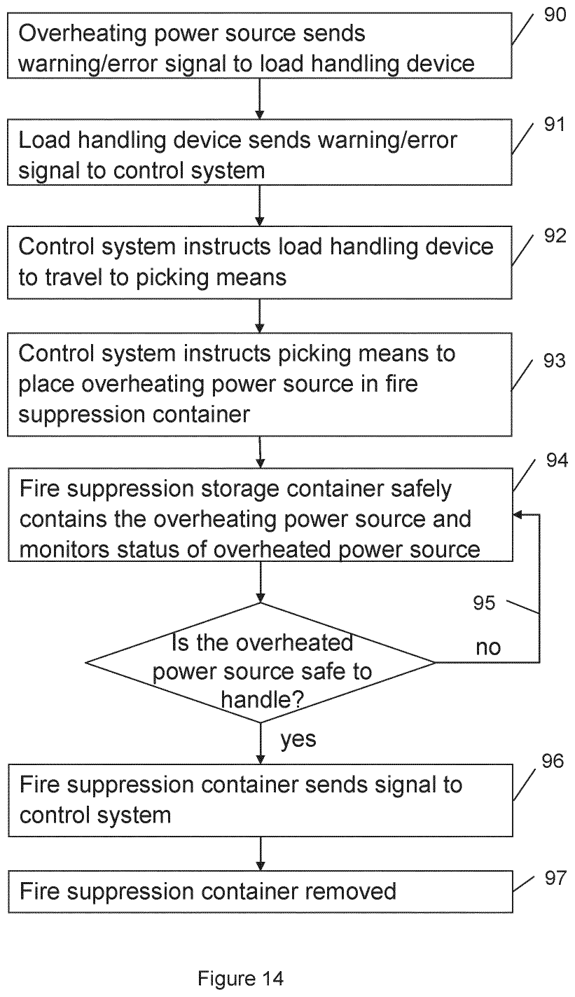

FIG. 14 is a flowchart illustrating a method of exchanging a power source 50 in a load handling device 31 in the particular case where the power source 50 is overheating. An overheated power source can be a power source that has exceeded a predetermined threshold temperature, for example a temperature at or slightly above the maximum operating temperature of the power source. The illustrated method is an automated process, with the advantage that overheating power sources can be safely and automatically contained.

In a step 90, the overheating power source sends a warning or error signal to load handling device. For example, the temperature of a power source installed within a load handling device can be monitored, and a signal sent when the temperature exceeds a predetermined threshold temperature. For example, a lithium ion battery could have a normal operating range of up to 60° C., and a predetermined threshold temperature of 65° C., so that if the battery temperature exceeds 65° C. the battery management system sends a warning signal to the load handling device. In other examples, the voltage of the power source can be monitored, and a signal sent when the temperature exceeds a predetermined threshold temperature. The monitoring can be done by a control system with sensors on the load handling device, either integrated into the power source (for example, a battery management system) or a separate system on the load handling device. The temperature and/or voltage and/or other characteristics of the power sources in the load handling devices can be continuously monitored during operation.

In a step 91, the load handling device sends a warning or error signal to a control system. As will be described later, one or more control systems may be provided to carry out functions including controlling the movement of load handling devices on the track system. The warning or error signal informs the control system that the power source is overheating.

In a step 92, in response to the warning or error signal from the load handling device, the control system instructs the load handling device to travel to the picking means, i.e. to a location on the track system where the power source can be exchanged. In examples where the exchange operation is carried out by a robot on the track system, the control system may instruct the load handling device to travel to a grid cell near to or adjacent to the robot. In examples where the exchange operation is carried out by at a power source exchange station, the control system may instruct the load handling device to travel to a grid cell near to or adjacent to the power source exchange station.

In a step 93, the control system instructs the picking means to place the overheating power source in a fire suppression container. The fire suppression container safely contains the overheating power source, and if the power source catches fire, the fire suppression container acts to suppress and safely contain the fire. In some examples, the fire suppression container may be equipped with sensors to monitor the status of the overheated power source (for example, temperature sensors to monitor the temperature).

In some examples the picking means can cover the fire suppression container with a fire-resistant lid or fire blanket. This helps to further suppress and contain a fire. One or more fire-resistant lids or fire blankets can be stored within reach of the picking means, for example next to the robot base or in an adjacent grid cell on the track system, or at a power source exchange station.

In a step 94, the control system determines whether the overheated power source is safe to handle, for example whether the temperature has dropped to within the normal operating range for the power source. For example, the temperature of the overheated power source can be compared to a second predetermined threshold temperature. The second predetermined threshold temperature may be the same as or different from the predetermined threshold temperature. For example, the predetermined threshold temperature may be at slightly above the highest normal operating temperature of the power source, and the second predetermined threshold temperature maybe be ambient temperature.

In a step 95, if the overheated power source is not safe to handle, for example if the temperature is above the second predetermined threshold temperature, the previous step 94 is repeated and the power source continues to be monitored.

In a step 96, if the overheated power source is safe to handle, for example if the temperature has dropped back down to below the second predetermined threshold temperature, the fire suppression container sends a signal to the control system, indicating that it is safe to retrieve the overheated power source.

In a step 97, the fire suppression container containing the overheated power source can be removed from the system, and then the overheated power source can be removed from the fire suppression container and safely disposed of. For example, a second load handling device can travel to the grid cell where the fire suppression container is located, lift the fire suppression container into its container-receiving space, and remove the fire suppression container. In examples where the fire suppression container is located at a power source exchange station, the fire suppression container can be removed from the rear of the power source exchange station.

The fire suppression container contains a fire suppressant material for suppressing fires, for example a granular material such as glass beads or perlite or vermiculite. If the power source catches fire, the fire suppressant material melts and thus absorbs heat from the power source, thereby providing a cooling effect that helps to extinguish the fire. Also the melted fire suppressant material forms an impervious layer around the power source, thus preventing oxygen from the air from reaching the power source, which also helps to extinguish the fire. An advantage of using a granular material is that the material is densely packed, and has a large surface area, which enables the fire suppressant material to surround the overheating power source closely and to melt quickly. In addition the fire suppressant material may be porous, and the porosity in conjunction with the large surface area is effective for absorbing liquids.

The melting point of the fire suppressant material may be above the thermal runaway threshold temperature, but below the temperature of a fire. The fire suppressant material would therefore melt and form an impervious layer surrounding the overheating power source only if thermal runaway occurs, and would deploy automatically in case of a fire. If the overheated power source cools down by itself before reaching the thermal runaway threshold temperature, the fire suppressant material will not melt, and can be reused.

The fire suppressant material may have a high specific heat capacity, in order to provide cooling to the power source as the fire suppressant material heats up. The fire suppressant material may have a high specific latent heat of melting, in order to provide cooling to the power source during the phase transition as the fire suppressant material melts.

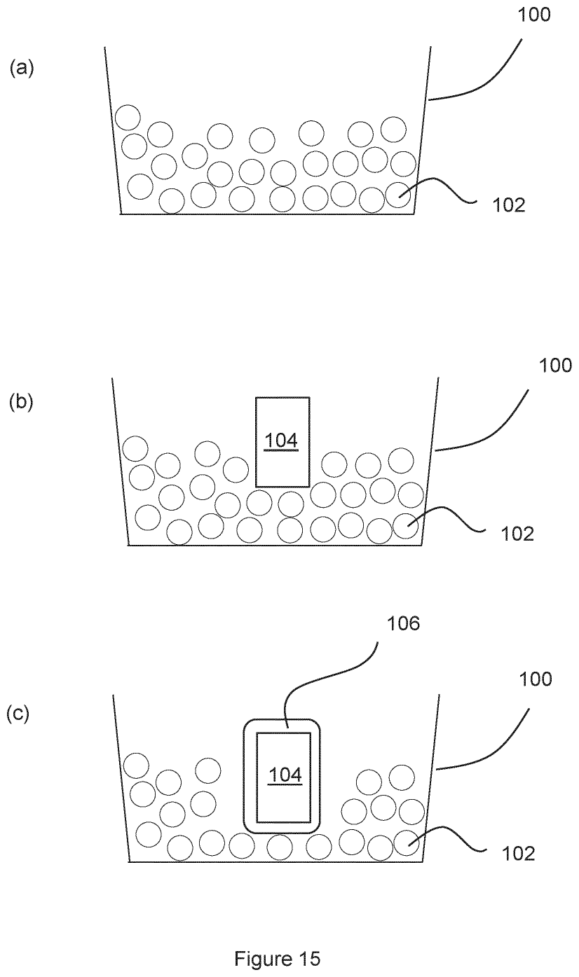

FIG. 15 (a to c) schematically illustrates a fire suppression container 100 partially filled with a granular fire suppressant material 102. In FIG. 15(a), the fire suppression container 100 is ready to receive an overheated power source (e.g. a power source that has exceeded a predetermined threshold temperature). In FIG. 15(b), an overheated power source 104 is placed into the fire suppression container 100. In cases where the overheated power source 104 does not exceed the threshold temperature for thermal runaway, the overheated power source 104 cools down. Once the overheated power source 104 has cooled down sufficiently (for example, dropped below a second predetermined threshold temperature or returned to its normal operating temperature), the fire suppression container 100 can be removed from the grid framework structure or from the power source exchange station.

In cases where the overheated power source 104 does exceed the threshold temperature for thermal runaway, the temperature of the overheated power source 104 increases rapidly until a fire starts. As illustrated in FIG. 15(c), the fire suppressant material 102 melts and forms an impervious layer 106 that surrounds the overheated power source 104. The fire is extinguished by the combined effect of cooling by the fire suppressant material 102, and the impervious layer preventing oxygen from reaching the overheated power source 104. Again, once the overheated power source has returned to its normal operating temperature, the fire suppression container 100 can be removed. The overheated power source 104 can then be safely disposed of.

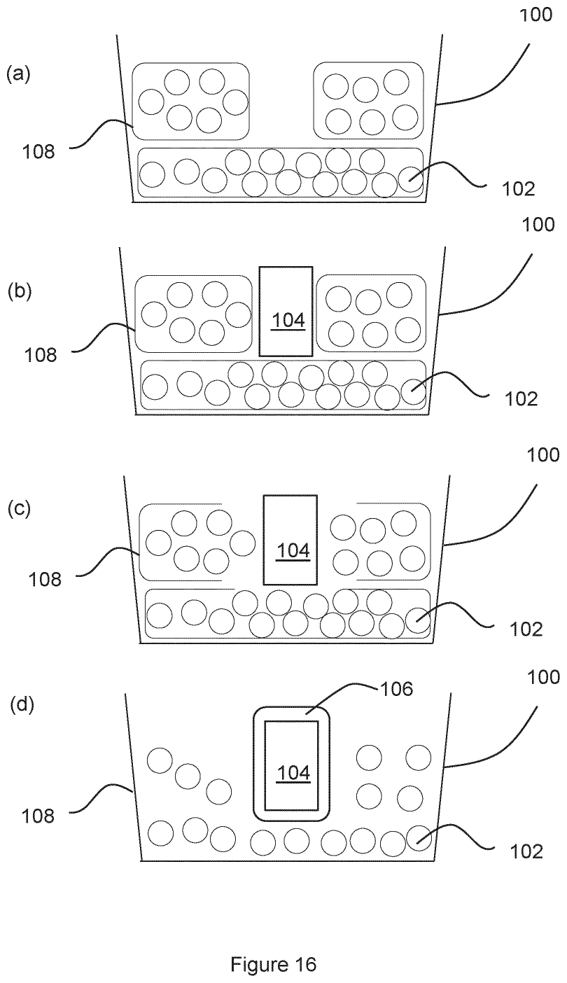

FIG. 16 (a to d) schematically illustrates a fire suppression container 100 partially filled with a granular fire suppressant material 102 contained in pouches 108. The advantage of the pouches is that the fire suppressant material 102 is contained, reducing the risk of spillage. In FIG. 16(a), the fire suppression container 100 is ready to receive an overheated power source. One or more pouches 108 containing the fire suppressant material are arranged inside the fire suppression container. In FIG. 16(b), an overheated power source 104 is placed into the fire suppression container 100. The overheated power source 104 is supported upon and surrounded by the pouches 108. In FIG. 16(c), the overheated power source is experiencing thermal runaway, and the material of the pouches 108 in contact with the overheated power source 104 has started to melt or burn away, thus releasing the fire suppressant material 102 from the pouches 108. In FIG. 16(d), the fire suppressant material 102 melts and forms an impervious layer 106 that surrounds the overheated power source 104. The fire is extinguished by the combined effect of cooling by the fire suppressant material 102, and the impervious layer preventing oxygen from reaching the overheated power source 104.

In some examples the picking means can cover the fire suppression container with a fire-resistant lid or fire blanket. This helps to further suppress and contain a fire. One or more fire-resistant lids or fire blankets can be stored within reach of the picking means, for example next to the robot base or in an adjacent grid cell on the track system, or at a power source exchange station. In response to detecting that a power source is overheating, the control system can automatically instruct the load handling device containing the overheated power source to travel to the picking means, then instruct the picking means to place the overheated power source in the fire suppression container, pick up the fire-resistant lid or fire blanket, and place the fire-resistant lid or fire blanket on top of the fire suppression container. In some cases, the fire-resistant lid or fire blanket may have sealing means, for example a fire-resistant lid may have clasps or magnets to seal the lid to the fire suppression container.

In some examples, the fire suppression container may be lined with a fire blanket or other fire suppressing material, for example fire resistant foam, either as an alternative to a granular fire suppressant material or in addition.

### Robot Arm

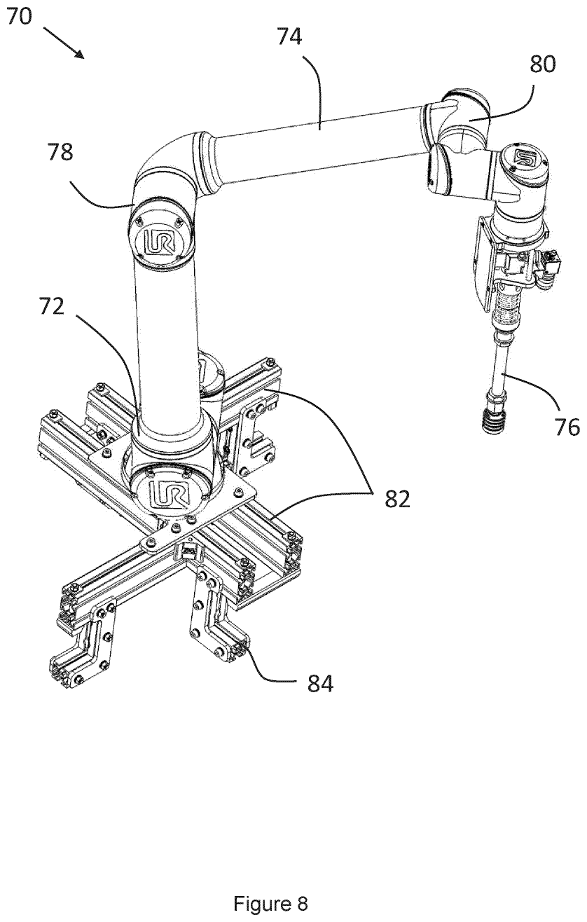

FIG. 8 is a perspective view of a robot arm 74 according to an aspect of the invention. The robot 70 comprises a robot base 72 and a robot arm 74 ending in an end effector 76 for holding a power source.

To provide multiple degrees of freedom of movement of the robot arm 74, and thus the end effector 76, the robot arm 74 comprises a plurality of moveable segments connected together by a plurality of pivotable joints, each of the plurality of pivotable joints providing rotation of the segments about one or more predetermined rotational axes, e.g. rotation about an axis along the arm (roll joint) and rotation about an axis transverse to the arm (pitch joint). In the particular embodiment of the present invention shown in FIG. 8, the robot arm 74 comprises upper and lower segments pivotally connected together by a robot elbow 78 to provide both roll and pitch joints between the lower and upper segments. The end effector 76 is rotatably connected to the distal end of the upper segment of the robot arm 74 to define a robot wrist 80. The robot wrist 80 provides rotation about an axis along the upper segment of the robot arm 74 and transverse to the robot arm 74. The pivotable joint connecting the upper and lower segments of the robot arm and the robot wrist connecting the end effector 76 provides six degrees of freedom of movement of the end effector 76. This allows the robot 70 to accurately position the end effector 76 into engagement with the power source 50.

In the embodiment illustrated in FIG. 8, the robot base 72 is mounted to horizontal supporting beams 82. Each of the horizontal supporting beams 82 is provided with a bracket 84 to enable the robot base to be mounted to a third grid cell 14c of a grid framework structure 1.

Operation of the robot arm and end effector is carried out by a control system comprising a processor and data storage means comprising computer executable instructions executed by the processor. The processor executes the computer executable instructions to cause movement of the robot arm and/or end effector.

### Location of Robot Arm

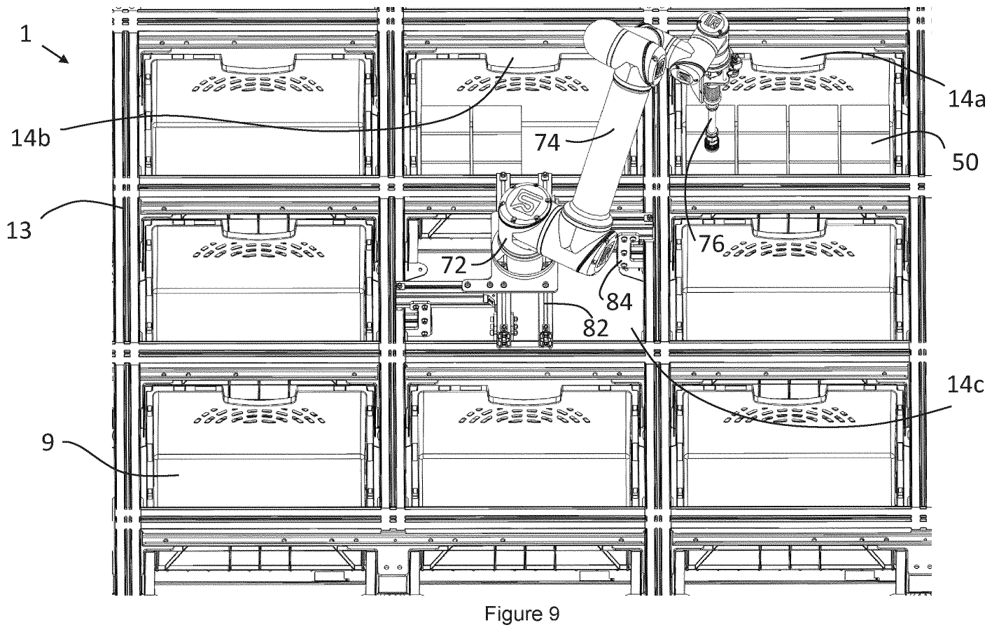

FIG. 9 is a perspective view of the robot 70 of FIG. 8 mounted to the third grid cell 14c of the grid framework structure 1. In the illustrated example, the robot 70 occupies the centre cell (the third grid cell 14c) of the 3×3 grid of cells illustrated, so the robot arm 72 can reach into any of the adjacent eight grid cells. All of the adjacent grid cells are occupied by a storage container, and two of the storage containers are being used to store power sources 50. These two storage containers are occupying the first and second grid cells 14a, 14b. The end effector 76 of the robot 70 is able to insert a power source 50 into a storage container 50 in an adjacent cell, or to retrieve a power source 50 from a storage container 50 in an adjacent cell. In other examples, the robot arm 72 may be able to reach further, to access grid cells that are not adjacent to the third grid cell 14c upon which the robot base 72 is mounted. Only the top level or layer of the grid framework structure 1 is visible in the figure, but it will be appreciated that the grid framework structure can be several layers deep. The visible storage containers can be the top storage containers 9 in stacks 11 of storage containers arranged in the storage columns 10 under the grid cells.

In the illustrated example, the robot base 72 is mounted to the third grid cell 14b. The horizontal supporting beams 82 are supported by the track system 13 of the grid framework structure. Each of the four horizontal supporting beams 82 is supported by one of the four edges of the third grid cell 14c, and each of the respective brackets 84 of the horizontal supporting beams hooks around and underneath the horizontal members 5,7 supporting the track system. Mounting the robot base 72 to a grid cell provides the advantage of stability for the robot 70. In the illustrated example the footprint of the robot base 72 is fully within one grid cell, so storage space is maximized.

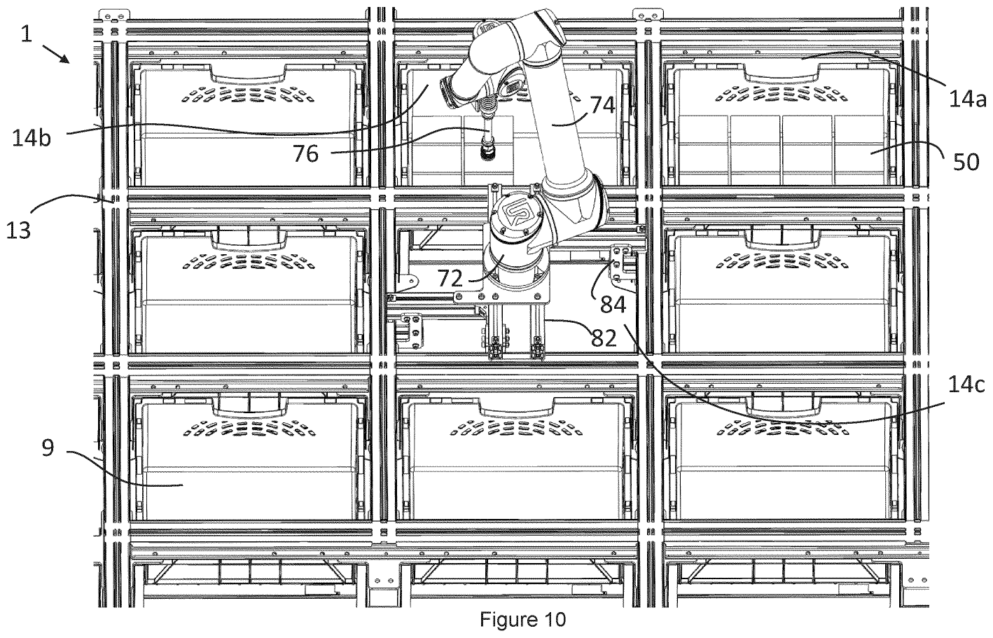

FIG. 10 illustrates the robot 70 of FIG. 9 in a different position. The configuration of pivotable joints of the robot 70 enables it to reach into a storage container in any adjacent grid cell.

### Load Handling Device

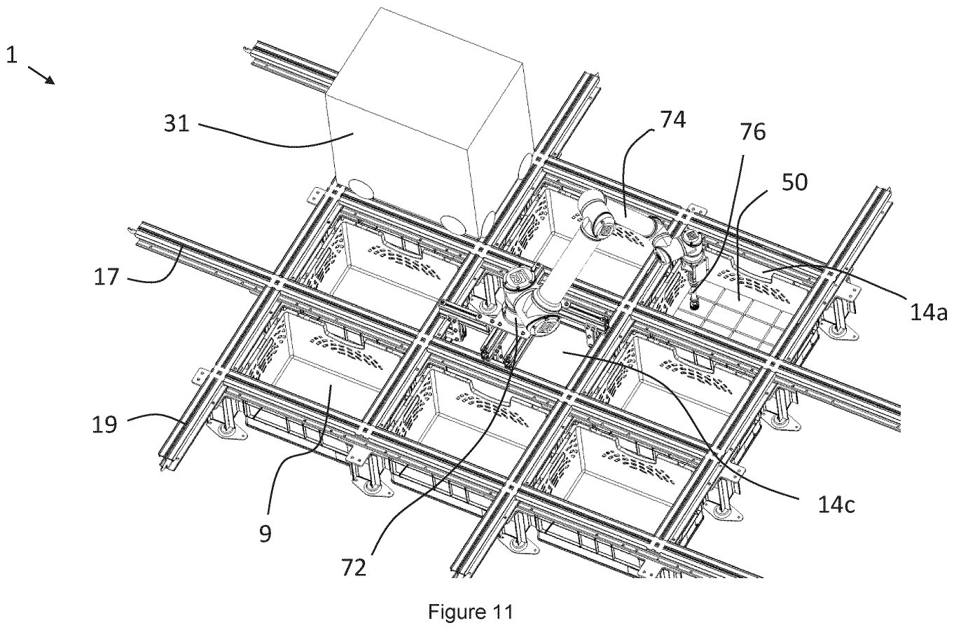

FIG. 11 is a perspective view of a load handling device 31 and a robot 70 on a grid framework structure 1. The load handling device 31 can approach the robot 70 by moving laterally on the track system to an adjacent or nearby grid cell. In the illustrated example, a load handling device 31 is on a grid cell diagonally adjacent to the third grid cell 14c upon which the robot base 72 is mounted. The robot arm 74 is able to reach both the load handling device 31 and the storage container 9 containing power sources 50 in another diagonally adjacent grid cell.

In cases where there are several load handling devices which need their power sources exchanging, there is sufficient space surrounding the robot 70 for several load handling devices to approach and occupy an adjacent grid cell. This improves the efficiency of the power source exchange process, because the next load handling device in the queue for exchange is in position and ready while the exchange operation is being carried out for the previous load handling device in the queue. There is no need for the robot 70 to wait for the next load handling device to approach before it can begin the power source exchange operation. This makes most efficient use of the robot 70, which is the limiting factor in the speed of exchanging power sources.

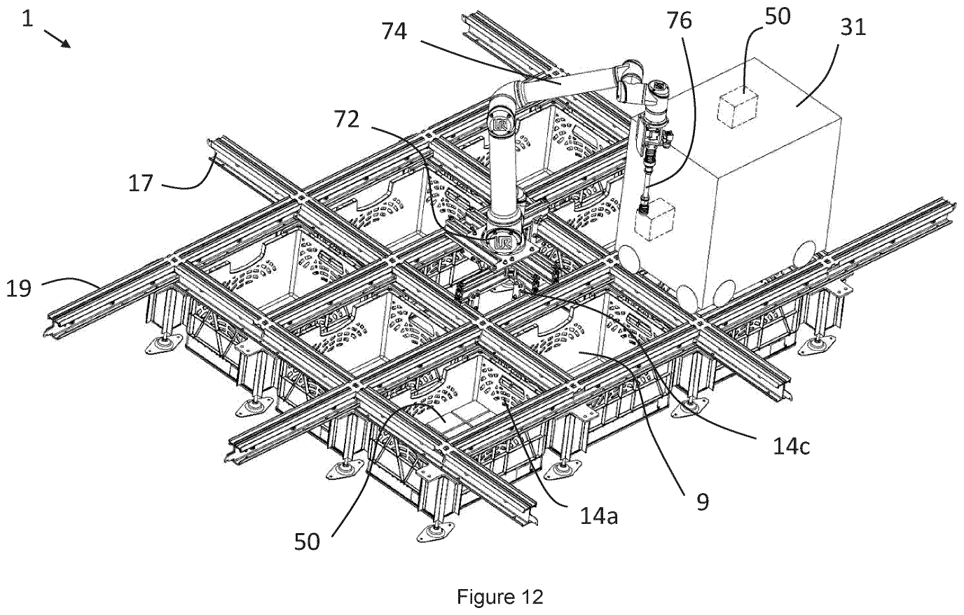

FIG. 12 is a perspective view of a load handling device and a robot arm mounted to a grid cell of a grid framework structure. The box illustrated with dashed lines represents the power source, and shows two possible points of entry of the power source into the load handling device. The power source can be inserted into or removed from the load handling device horizontally or vertically. An aperture may be provided on the top or on one or more sides of the body of the load handling device, in order to facilitate insertion or removal of the power source. In some examples, guides or rails may be provided to locate the power source as it enters or exits the load handling device.

### End Effector

The end effector 76 can take different forms, for example a suction cup or gripper or clamping device. The end effector as illustrated in FIGS. 8 to 12 is a suction cup, which can be placed on the top surface or a side surface of a power source and activated in order to exert a suction force to retain the power source on the suction cup. The robot arm 74 can then move the power source to the required position, and the suction force is deactivated in order to release the power source.

A suction cup is not the only option; any end effector that is capable of manipulating a power source is applicable in the current invention. In examples where the end effector is a gripper or clamping device, the power source may have features that cooperate with the end effector (for example, holes or indentations or a rim). In some cases the power source may be provided with a case or cover, and the case or cover may have features that cooperate with the end effector.

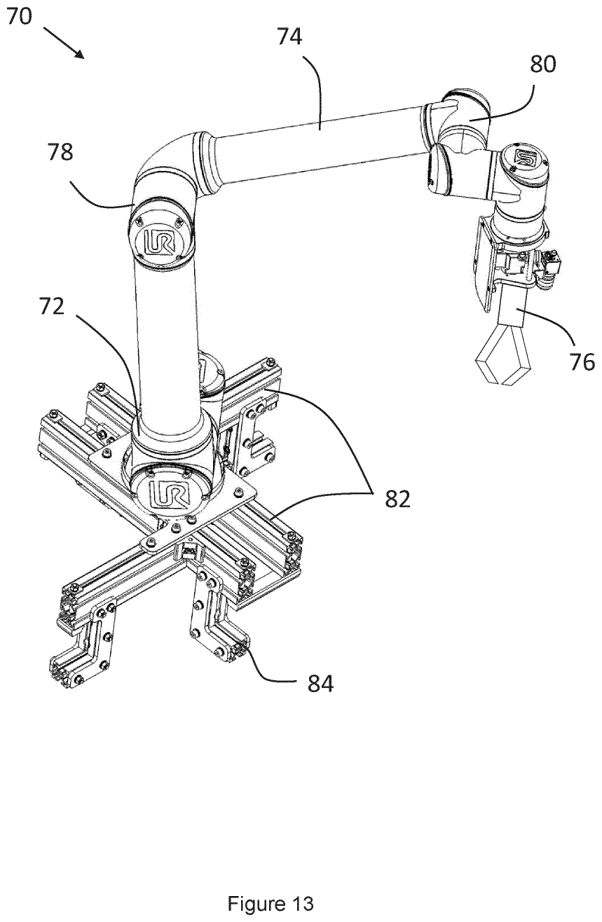

FIG. 13 is a perspective view showing a robot arm with an end effector 76 comprising a clamping device or gripper device. The clamping device can function as an end effector 76 coupled to the robot arm 74 of the robot 70, as shown in FIG. 13. The clamping device is mounted to the robot arm 74 to define the end effector 76. The movement of the robot arm 74 and the clamping device is controlled by a control system. The control system is configured to control the movement of the robot arm 74, and thus the end effector 76 such that the pair of clamps of the clamping device is positioned to clamp the opposing walls of a power source 50. One or more pressure sensors can be mounted on the clamps in order to provide a signal to the control system of engagement with the walls of the power source. Once clamped, the control system is then able to cause the robot arm 74 to lift the power source out of the load handling device.

### Power Source Exchange Operation

This section describes in detail how the robot 70 carries out the method of exchanging a power source 50 in a load handling device 31. The steps of the method are illustrated schematically in FIGS. 6 and 7. Movement of the robot arm and/or end effector of the robot 70 is instructed by a control system having a memory storing computer executable instruction and a processor. The computer executable instructions provide instructions to the robot when executed by the processor.

The robot base 72 of the robot 70 is mounted to the third grid cell 14c of the grid framework structure 1. This provides stability for the robot 70, and allows the end effector 76 of the robot arm 74 to remove a first power source 50a from the load handling device 31 and to replace it with a second power source 50b. Since the exchange takes place on the track system of the grid framework structure, there is no need to transport the load handling device 31 to a charge station or an exchange station. The first power source 50a referred to here may represent a depleted power source, and the second power source 50b may represent a fully charged power source.

The first step 60 is instructing movement of the robot arm 74 by the control system such that the end effector 76 coupled to the robot arm 74 engages with the first power source 50a installed in the load handling device 31. The end effector may engage, for example, by suction or clamping or gripping of either the first power source 50a itself or a cover or case of the first power source. Once the end effector 76 has engaged with the first power source 50a, the robot arm 74 is instructed to remove the first power source from the load handling device 31. Removal of the first power source from the load handling device 31 can simply be a vertical and/or lateral movement of the robot arm.

In the second step 62, the robot arm 74 then moves to enter the first grid cell 14a comprising the first storage container 9a. The robot arm 74 can then deposit the first power source 50a into the first storage container 9a in the first grid cell 14a. The end effector 76 is then instructed to disengage with the first power source 50a.

In the third step 64, the robot arm 74 is instructed to move to the second grid cell 14b such that the end effector 76 enters the second storage container 9b in the second grid cell 14b. The end effector 76 engages the second power source 50b in the second storage container 9b, picks up the second power source 50b and removes it from the second container 9b in the second grid cell 14b.

In the fourth step 66, the robot arm 74 can then be instructed to approach the load handling device 31 and insert the second power source 50b into the load handling device. The end effector 76 then disengages with the second power source 50b.

A camera (not shown) may be mounted to the robot arm 74 for viewing the area in which the end effector 76 will operate. The camera may include any suitable camera or cameras, such as one or more infrared cameras and may include a 3-dimensional depth camera. The camera may be provided with lighting elements to illuminate the interior of the grid cell when inserting or removing a power source. Images from the camera are fed to the control system where the images are processed so as to assist in the identification and/or picking up of the power source and/or positioning within the storage container. For example, the camera can identify the areas of the storage container that have space to position so as to enable the end effector to move within the storage container and to pick up the power source. A camera mounted to the robot arm or end effector to guide and position the end effector can act as an alignment mechanism.

### Securing Mechanism

The load handling device 31 may comprise a securing mechanism to secure a power source 50 within the load handling device. The securing mechanism is used to retain the power source 50 within the load handling device 31 as it moves on the track system 13. The securing mechanism can comprise any suitable mechanism known in the art, for example, securing pins or grippers.

In some examples, the securing mechanism may provide the electrical coupling between the power source and the driving mechanism 38. This has the advantage of a simpler construction with fewer parts: instead of two separate systems for securing and for electrically coupling the power source 50, one system can perform both functions.

### Power Source Exchange Station

Although in the example described above the power source exchange occurs on the track system, in other examples the power source exchange can be carried out at a dedicated power source exchange station. For example, one or more power source exchange stations can be located at the edge of the grid framework structure, adjacent to the track system 13, rather than on the track system 13 itself as in previous examples. The power source exchange station can be located on a platform or mezzanine adjacent to the track system 13. In this case, instead of the first and second storage containers and the fire suppression container being standard storage containers of the type used for storage of goods or items in the grid framework structure, the first and second storage containers and the fire suppression container can be dedicated containers located on the platform at or close to the power source exchange station, rather than occupying grid cells of the track system.

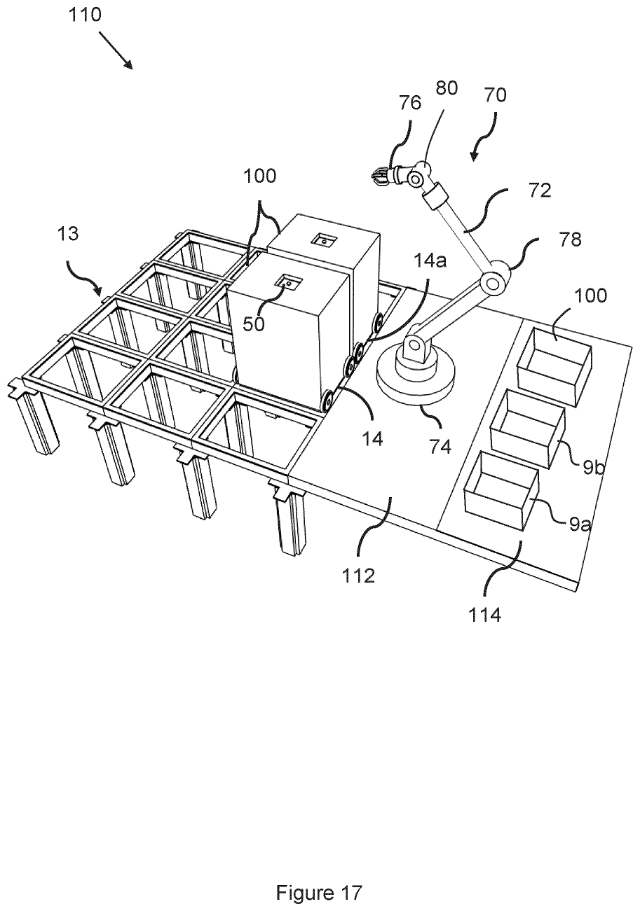

For example, FIG. 17 shows an example power source exchange station 110 in the form of a robot 70 located on a platform 112 adjacent to the outer perimeter of a portion of the track system 13. The robot 70 comprises a robot base 72, a robot arm 74, and an end effector 76 at the end of the robot arm. The robot base 72 is fixed with respect to the track system 13 by mounting it on the platform 112. The illustrated end effector 76 is in the form of a gripper for physically grasping the power source; however, the end effector 76 may take any form suitable for releasably holding the power source 50. The end effector 76 comprises a pair of gripping members selectively moveable between a gripping position for holding the power source 50 and a release position for releasing the power source 50. The robot base 72 and the end effector 76 are connected by a series of linkages and joints 78, 80. The joints are configured to give the robot arm 74 the desired degrees of freedom to allow it to remove a power source 50 from a power source compartment in the load handling device 31 and place it in a designated area 114, and/or to pick up a replacement power source 50 from a designated area 114 and insert it into the power source compartment. In this illustrated example, the robot arm 74 is a 6-axis robotic arm (i.e. the joints provide six degrees of freedom), which allows for relatively complex movements that provides flexibility with regard to the relative positioning between the load handling device 31, the robot arm 74 and the designated area 114.

The robot 70 is configured to exchange the power source 50 of a load handling device 31 that is located on a designated grid cell 14 adjacent to the robot 70. Depending on the size and configuration of the robot 70, the robot 70 may be configured to interact with a load handling device 31 on any one of a plurality of designated grid cells 14 in the vicinity of the robot 70. In other words, the end effector 76 of the robotic arm 74 may be movable to the power source compartments of at least two load handling devices 31 that are in the vicinity of the robot arm 74, as shown in FIG. 17. This allows the robot arm 74 to continue performing power source exchanges even if a load handling device 31 malfunctions and blocks one of the designated grid cells 14.

In the example illustrated in FIG. 17, the robot 70 removes the first power source 50a from a power source compartment in the load handling device 31 and places it in the first storage container 9a in a designated area 114, then picks up the second power source 50b from the second storage container 9b in the designated area 114 and inserts the second power source 50b into the power source compartment of the load handling device 31. In addition to the first and second storage containers 9a, 9b, a fire suppression container 100 is located in the designated area 114 of the power source exchange station 110.

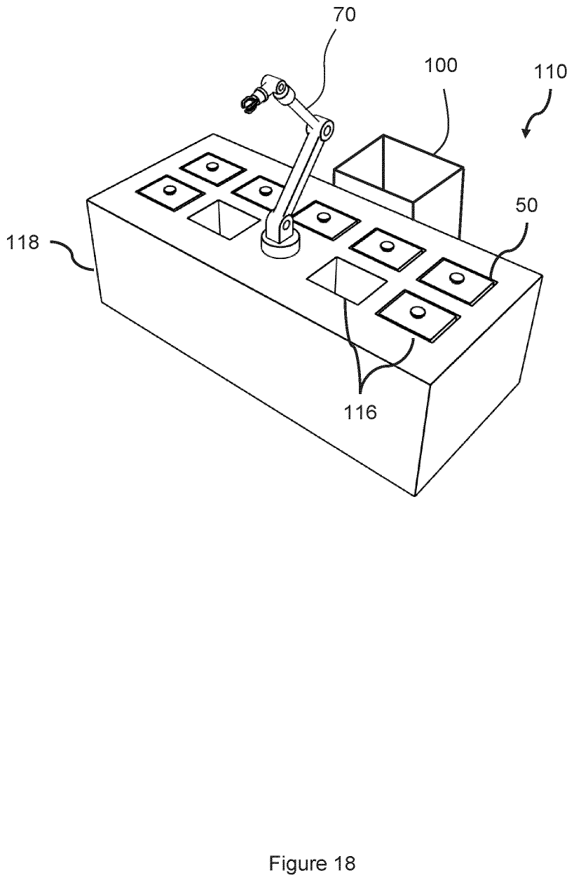

FIG. 18 shows an example power source exchange station 110 with power source holders 116 arranged in a horizontal plane within a storage structure 118. In this example, each power source holder 116 comprises a top-facing opening in a top surface of the storage structure 118 to allow each power source holder 116 to removably receive a power source 50. The region in the storage structure 118 below the power source holders 116 may be used to house power source charging equipment for charging the power sources 50 when they are received in the power source holders 116.

The power source holders 116 of the above-described power source exchange station 110 are optionally accessible from a rear side of the power source exchange station 110 to allow a power source 50 to be inserted into or removed from the power source holders 116 from the rear side of the power source station 110. The rear side is defined as a side of the power source exchange station 110 facing away from the track system 13. The rear side of the power source exchange station 110 may face a maintenance area accessible by human workers. This arrangement allows a power source 50 to be removed from the power source exchange station 110 by a human worker (e.g. for maintenance) without the worker having to be located in an area with potentially dangerous equipment (e.g. the track system 13, the load handling devices 31, the robot 70, etc.), or without having to shut down the potentially dangerous equipment.

In the example illustrated in FIG. 18, the first and second storage containers are power source holders 116 in the storage structure 118 of the power source exchange station 110. In use, the robot 70 removes the first power source from a power source compartment in the load handling device (not shown) and places it in the first storage container in storage structure 118, then picks up the second power source from the second storage container in the storage structure 118 and inserts the second power source into the power source compartment of the load handling device. The power source exchange station 110a also comprises a fire suppression container 100, in this example located at the rear side of the storage structure 118. In the event that a power source in a load handling device is overheating, the load handling device travels to the power source exchange station 110, the robot 70 removes the overheating power source from the load handling device and places the overheating power source into the fire suppression container 100. After the overheating power source has cooled down and is safe to handle, the fire suppression container 100 can easily be removed from the rear of the power source exchange station 110 and taken to a maintenance area.

The location of the power source exchange station 110 described above are not limited to being adjacent to the outer perimeter of the track system 13. The power source exchange station 110 may be located at any other suitable location accessible by the end effector of a robot arm, e.g. on the track system 13 itself.

In some examples, a robot 70 may be mounted on the power source exchange station 110 itself. For example, FIG. 18 shows a robot 70 with an articulated robot arm 74 mounted on the top surface of the storage structure 118 of the power source exchange station 110. This power source exchange station 110 may be located adjacent to the outer perimeter of the track system 13 such that the end effector of the robot arm 74 can transfer a power source 50 between a power source holder 116 and a load handling device 31 located on a designated grid cell 14 adjacent to the power source exchange station 110. Instead of an articulated robot arm 74, a robot arm 74 in the form of a gantry or Cartesian robot may be mounted on the power source exchange station 110.

In some examples, each power source exchange station 110 may be associated with a plurality of robots 70. In other words, a plurality of robots 70 may be configured to transfer power sources 50 to and from the same power source exchange station 110. For example, a plurality of robot arms 74 may be mounted on, or in the vicinity of, a single power source exchange station 110 to allow the power sources 50 of multiple load handling devices 31 to be exchanged during the same time period or during overlapping time periods at a single power source exchange station 110.

In the case where the power source 50 is a rechargeable power source, the power source holders 116 of the power source exchange stations 110 described above preferably comprise power source charging means for charging the power sources 50 when received in the holders. For example, the power source holders 116 may comprise electrical connectors (not shown) configured to couple to the electrical connectors of the power source 50, together with an external power supply (e.g. a mains power supply) and other electrical equipment (e.g. transformer, convertor etc.) to allow the external power supply to charge the power sources 50 when they are received in the power source holders 116.

### Control System

One or more control systems may be provided, to carry out functions including but not limited to controlling the movement of load handling devices on the track system, tracking charge levels in power sources, instructing the robot arm when to exchange power sources, tracking the number and charge levels of power sources stored in storage containers, controlling when and how to remove storage containers from the grid framework structure, controlling the movement of the robot arm and end effector, and where applicable controlling the securing mechanism and movement of the robot wheeled base. These operations can be carried out by the same control system or by different control systems.

### Storage Container

The first and second storage containers 9a, 9b may be the same as other storage containers 9 in the grid framework structure 1 used for storing products, or the first and second storage containers 9a, 9b may be specialized storage containers adapted or configured for the storage of power sources 50.

The first and second storage container 9a, 9b can be configured to contain one power source, or a plurality of power sources. In the examples illustrated in FIGS. 9 to 12, one storage container is configured to accommodate up to 12 power sources, arranged in a grid of 4×3. Other configurations are possible.

The first and second storage containers may be provided with one or more compartments to hold one or more power sources. In some examples these compartments may be formed by separators. In some examples the first and second storage containers may be fireproof.

### Power Source Technologies

Examples of power sources include but are not limited to lithium ion batteries, lithium-ion polymer batteries, lithium-air batteries, lithium-iron batteries, lithium-iron-phosphate batteries, lead-acid batteries, nickel-cadmium batteries, nickel-metal hydride batteries, nickel-zinc batteries, sodium-ion batteries, sodium-air batteries, thin film batteries, smart battery carbon foam-based lead acid batteries, capacitors, supercapacitors, ultracapacitors, lithium capacitors, electrochemical double layer capacitors, electric double layer capacitors, pseudocapacitors, or hybrid capacitors.

### Definitions

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the 25 possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” 30 and its derivatives are intended to include the possibilities of direct and indirect contact.

For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the 5 possibility that x is directly mounted on y, with no intervening components, and the possibility that x is indirectly mounted on y, with one or more intervening components.

In this document, the word “comprise” and its derivatives are intended to have an inclusive rather than an exclusive meaning. For example, “x comprises y” is intended to include the possibilities that x includes one and only one y, multiple y's, or one or 10 more y's and one or more other elements. Where an exclusive meaning is intended, the language “x is composed of y” will be used, meaning that x includes only y and nothing else.

In this document, the term “fully charged” applied to an exchangeable rechargeable power source means that the exchangeable rechargeable power source is provided with its rated charge. For a battery, this means that the battery voltage is the rated voltage. The term “depleted” applied to an exchangeable rechargeable power source means that there is a predetermined residual charge left in the exchangeable rechargeable power source. For a battery, this means that the battery voltage has dropped below the rated voltage to a predetermined residual voltage.

1-16. (canceled)

17. A method for exchanging a power source in a load handling device operative on a grid framework structure, the grid framework structure including:
i) a track system including a first set of tracks extending in a first direction and a second set of tracks extending in a second direction, the second direction being substantially perpendicular to the first direction, the track system extending in a substantially horizontal plane and forming a grid pattern containing a plurality of grid cells;
ii) a plurality of upright columns supporting the track system; and
iii) a plurality of stacks of storage containers arranged in a plurality of storage columns located below the track system,
the method comprising:
a) removing a first power source from the load handling device;
b) inserting the first power source into a first storage container in a first grid cell;
c) removing a second power source from a second storage container in a second grid cell; and
d) inserting the second power source into the load handling device.

18. The method of claim 17, comprising:
instructing a second load handling device to remove the first storage container containing the first power source from the first grid cell, optionally wherein the second load handling device is the load handling device or is a different load handling device.

19. The method of claim 18, comprising:
instructing a third load handling device to deposit an empty storage container into the first grid cell, wherein the third load handling device is the load handling device or is a different load handling device.

20. The method of claim 18, comprising:
charging the first power source after the first storage container has been removed from the first grid cell.

21. The method of claim 17, comprising:
instructing a fourth load handling device to remove the second storage container from the second grid cell, wherein the fourth load handling device is the load handling device or is a different load handling device.

22. The method of claim 21, comprising:
instructing a fifth load handling device to deposit a storage container containing one or more power sources in the second grid cell, wherein fifth load handing device is the load handling device or is a different load handling device.

23. The method of claim 17, wherein the load handling device comprises:
a securing mechanism configured to releasably secure a power source within the load handling device.

24. The method of claim 16, wherein the load handling device comprises:
an auxiliary power source.

25. The method of claim 17, wherein the first and/or second storage container comprises:
one or more compartments configured to contain a power source.

26. The method of claim 16, wherein the first storage container comprises:
a fire suppression container containing a fire suppressant material for safely containing an overheated power source.

27. A system for exchanging a power source in a load handling device on a grid framework structure, the system including:
i) a grid framework structure including a track system including a first set of tracks extending in a first direction and a second set of tracks extending in a second direction, the second direction being substantially perpendicular to the first direction, the track system extending in a substantially horizontal plane and forming a grid pattern containing a plurality of grid cells;
ii) a plurality of upright columns supporting the track system;
iii) a plurality of stacks of storage containers arranged in a plurality of storage columns located below the track system;
iv) a load handling device including a first power source for supplying power to move the load handling device on the track system;
v) a first storage container in a first grid cell;
vi) a second storage container containing a second power source for the load handling device, the second storage container being arranged in a second grid cell; and
vii) picking means configured for removing/inserting a power source from/into the load handling device.

28. The system of claim 27, comprising:
a control system configured to control the picking means to perform:
a) removing a first power source from the load handling device;
b) inserting the first power source into a first storage container in a first grid cell;
c) removing a second power source from a second storage container in a second grid cell; and
d) inserting the second power source into the load handling device.

29. The system of claim 27 wherein the picking means comprises:
a robot including a robot base and a robot arm coupled to the robot base, the robot base being located on a third grid cell of the track system.

30. The system of claim 29, wherein the robot base is mounted to the third grid cell.

31. The system of claim 29, wherein the robot base comprises:
a wheel assembly and is configured to move on the track system of the grid framework structure.

32. The system of claim 27, wherein the first container is a fire suppression container comprising:
a fire suppressant material for safely containing an overheated power source.
